(19) United States
(12) Patent Application Publication
(10) Pub. No.: US 2003/0098780 A1
(43) Pub. Date: May 29, 2003

(54) General access control features for a RF access control system

(76) Inventors: Ronald Taylor, Wheaton, IL (US); Eric V. Gonzales, Aurora, IL (US); James F. Wiemeyer, Homer Glen, IL (US)

Correspondence Address: McAndrews, Held & Malloy, Ltd., 500 W. Madison Street, 34th Floor, Chicago, IL, 60661, US

(21) Appl. No.: 10/262,507

(22) Filed: Sep. 30, 2002

Related U.S. Application Data
(60) Provisional application No. 60/326,338, filed on Sep. 30, 2001.
(60) Provisional application No. 60/326,299, filed on Sep. 30, 2001.
(60) Provisional application No. 60/326,201, filed on Sep. 30, 2001.
(60) Provisional application No. 60/326,316, filed on Sep. 30, 2001.
(60) Provisional application No. 60/326,298, filed on Sep. 30, 2001.
(60) Provisional application No. 60/326,179, filed on Sep. 30, 2001.
(60) Provisional application No. 60/326,296, filed on Sep. 30, 2001.
(60) Provisional application No. 60/326,294, filed on Sep. 30, 2001.
(60) Provisional application No. 60/326,295, filed on Sep. 30, 2001.

(51) Int. Cl. H04Q 1/00; H04B 1/00; H04B 3/00; G06F 7/00; G06F 7/04; H04Q 9/00; H04L 9/14; H04L 9/32; G06K 19/00; G08C 19/00; G05B 19/00; G05B 23/00; G08B 29/00; H04B 1/38

(52) U.S. Cl. 340/5.61; 340/5.2

(57) ABSTRACT

A wireless access control system including a Wireless Access Point Module (WAPM) that provides automatic determination of reader interface. Thus, the WAPM may be employed with any of a variety of external identity readers and may operate with the readers right away, without external reprogramming. Additionally, the WAPM may use encrypted RF transmissions in transmitting data to a Wireless Panel Interface Module (WPIM). Additionally, the WAPM may be placed in an extended unlock mode for areas where unsecured access it to be allowed for a specified time, such as during business hours.

### RELATED APPLICATIONS

The present application claims priority to the following provisional applications all filed Sep. 30, 2001: Application No. 60/326,338, entitled “RF Channel Linking Method and System”; Application No. 60/326,299, entitled “Energy Saving Motor-Driven Locking Subsystem”; Application No. 60/326,201 entitled “Cardholder Interface for an Access Control System”; Application No. 60/326,316, entitled “System Management Interface for Radio Frequency Access Control”; Application No. 60/326,298 entitled “Power Management for Locking System”; Application No. 60/326,179, entitled “General Access Control Features for a RF Access Control System”; Application No. 60/326,296, entitled “RF Wireless Access Control for Locking System”; Application No. 60/326,294, entitled “Maintenance/Trouble Signals for a RF Wireless Locking System”; and Application No. 60/326,295, entitled “RE Dynamic Channel Switching Method.”

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

The preferred embodiments of the present invention relate to an RF access control system for controlling access to an access point. More specifically, the preferred embodiments of the present invention relate to a method and system for general access control features for a wireless access control system.

A wireless access control system may provide several advantages over a traditional, wire-based access control system. In a traditional, wired access control system, each access point, such as a door, for example, is equipped with a locking module to secure the access point. Each locking module is in turn directly wired to a remote access control module. The access control module is typically a database that compares a signal received from the locking module to a stored signal in the database in order to determine an access decision for that locking module. Once the access decision has been determined by the access control module, the decision is relayed to the locking module through the wired connection.

The use of wired connections between the access control module and the locking module necessitates a large investment of time and expense in purchasing and installing the wires. For example, for larger installations, literally miles of wires must be purchased and installed. An access control system that minimizes the time and expense of the installation would be highly desirable.

Additionally, wire-based systems are prone to reliability and security failures. For example, a wire may short out or be cut and the locking module connected to the access control module by the wire may no longer be under the control of the access control module. If a wire connection is cut or goes, the only alternative is to repair the faulty location (which may not be feasible) or run new wire all the way from the access control module to the locking module, thus incurring additional time and expense. Conversely, an access control system that provides several available communication channels between the locking module and the access control module so that if one communication channel is not usable, communication may proceed on one of the other communication channels, would also be highly desirable, especially if such an access control system did not add additional costs to install the additional communication channels.

A wireless access system providing a wireless communication channel between the locking module and the access control module may provide many benefits over the standard, wire-based access control system. Such a wireless access system is typically less expensive to install and maintain due to the minimization of wire and the necessary installation time. Additionally, such a system is typically more secure because communication between the locking module and the access control module is more robust that a single wire.

However, one difficulty often encountered in installing and maintaining such a wireless access system is ensuring the security of transmitted signals. For example, the wireless access system must prevent unauthorized persons from observing and reproducing a wirelessly transmitted signal in order to gain access through the system. Consequently, a system for providing higher security to wireless transmissions would be highly desirable.

Additionally, several system for access identification such as magnetic card readers, proximity card readers, biometric identifiers, and Wiegand card readers are currently available. A wireless access system that is able to interface with several of these systems would be highly desirable, especially if such a system was able to automatically determine the reader interface and communicate with the reader immediately.

Additionally, a wireless access system that provides for an access point such as a door to be held in a specific base state for a predetermined amount of time would also be highly desirable.

### BRIEF SUMMARY OF THE INVENTION

The present invention provides elements for general access control in a RF access control system. A Wireless Access Point Module (WAPM) is presented that includes automatic determination of reader interface. Thus, the WAPM may be employed with any of a variety of external identity readers and may operate with the readers right away, without external reprogramming. Additionally, the WAPM may perform extended unlocks and use encrypted RF transmissions in transmitting data to a Wireless Panel Interface Module (WPIM).

### BRIEF DESCRIPTION OF SEVERAL VIEWS OF THE DRAWINGS

FIG. 1 illustrates a block diagram of the components of a wireless access system according to a preferred embodiment of the present invention.

FIG. 2 illustrates a block diagram of the components of an expanded wireless access system according to a preferred embodiment of the present invention.

FIG. 3 illustrates a Wireless Access Point Module (WAPM) for the wireless access system of FIG. 1 according to a preferred embodiment of the present invention.

FIG. 4 illustrates a WPIM for the wireless access system of FIG. 1 according to a preferred embodiment of the present invention.

FIG. 5 illustrates a flowchart of the determination of the reader interface type at the WAPM according to a preferred embodiment of the present invention.

FIG. 6 illustrates a flowchart of the extended unlock mode according to a preferred embodiment of the present invention.

### DETAILED DESCRIPTION OF THE INVENTION

The present application is directed toward a portion of a wireless access system. Additional disclosure of the wireless access system may be found in the following co-filed applications which are hereby incorporated by reference in their entirety: Application No. __/___,___, entitled “RF Channel Linking Method and System” filed Sep. 30, 2002; Application No. __/___,___, entitled “Energy Saving Motor-Driven Locking Subsystem” filed Sep. 30, 2002; Application No. __/___,___ entitled “Cardholder Interface for an Access Control System” filed Sep. 30, 2002; Application No. __/___,___, entitled “System Management Interface for Radio Frequency Access Control” filed Sep. 30, 2002; Application No. __/___,___ entitled “Power Management for Locking System” filed Sep. 30, 2002; Application No. __/___,___, entitled “General Access Control Features for a RF Access Control System” filed Sep. 30, 2002; Application No. __/___,___, entitled “RF Wireless Access Control for Locking System” filed Sep. 30, 2002; Application No. __/___,___, entitled “Maintenance/Trouble Signals for a RF Wireless Locking System” filed Sep. 30, 2002; and Application No. __/___,___, entitled “RF Dynamic Channel Switching Method” filed Sep. 30, 2002.

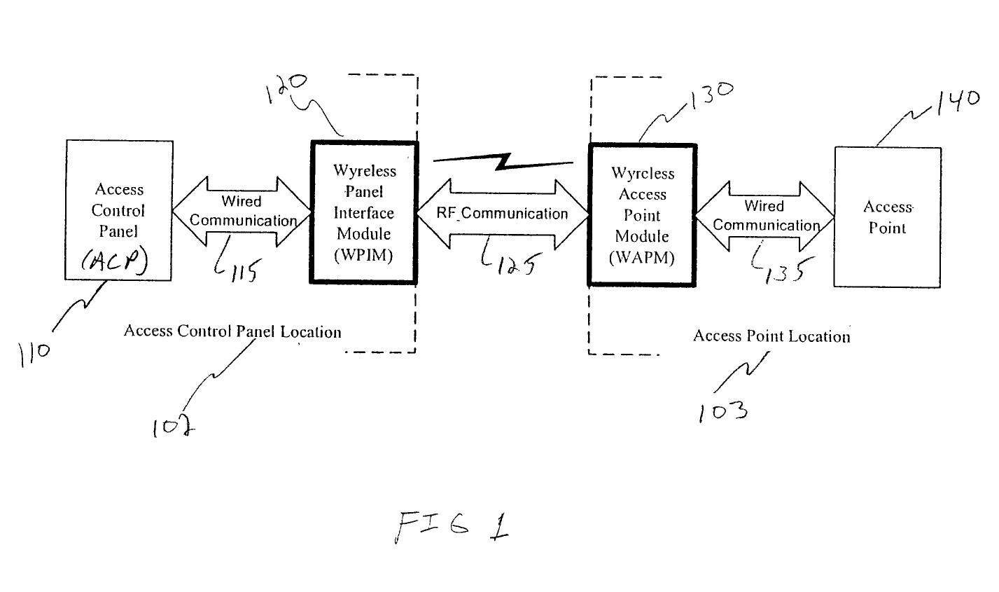

FIG. 1 illustrates a block diagram of the components of a wireless access system 100 according to a preferred embodiment of the present invention. The wireless access system 100 includes several components installed at one of two generalized locations, an access control panel location 102 and an access point location 103. The access control panel location 102 includes an access control panel (ACP) 110 and a Wireless Panel Interface Module (WPIM) 120. The access point location 103 includes a Wireless Access Point Module (WAPM) 130 and an access point 140. The access control panel 110 communicates with the WPIM 120 through a bi-directional wired communication link 115. The WPIM 120 communicates with the WAPM 130 through a bi-directional RF communication link 125. The WAPM 130 communicates with the access point 140 through a bi-directional wired communication link 135. The access point 140 is preferably a door or portal, but may be a container, secure location, or a device of some kind, for example.

In operation, an access signal is read at the access point 140. The access signal may be a signal from an access card, for example, a magnetic stripe or Wiegand access card. Alternatively, the access signal may be a biometric or a numeric sequence or some other access signal. The access signal is relayed from the access point 140 to the WAPM 130 through the wired communication link 135. As further described below, the access point 140 may be integrated into the WAPM 130 to form a single component or may be a separate component wired to the WAPM 130.

Once the WAPM 130 receives the access signal from the access point 140, the WAPM 130 transmits the access signal to the WPIM 120 over the RF communication link 125. The WPIM 120 receives the access signal and relays the access signal to the ACP 110 over the wired communication link 115.

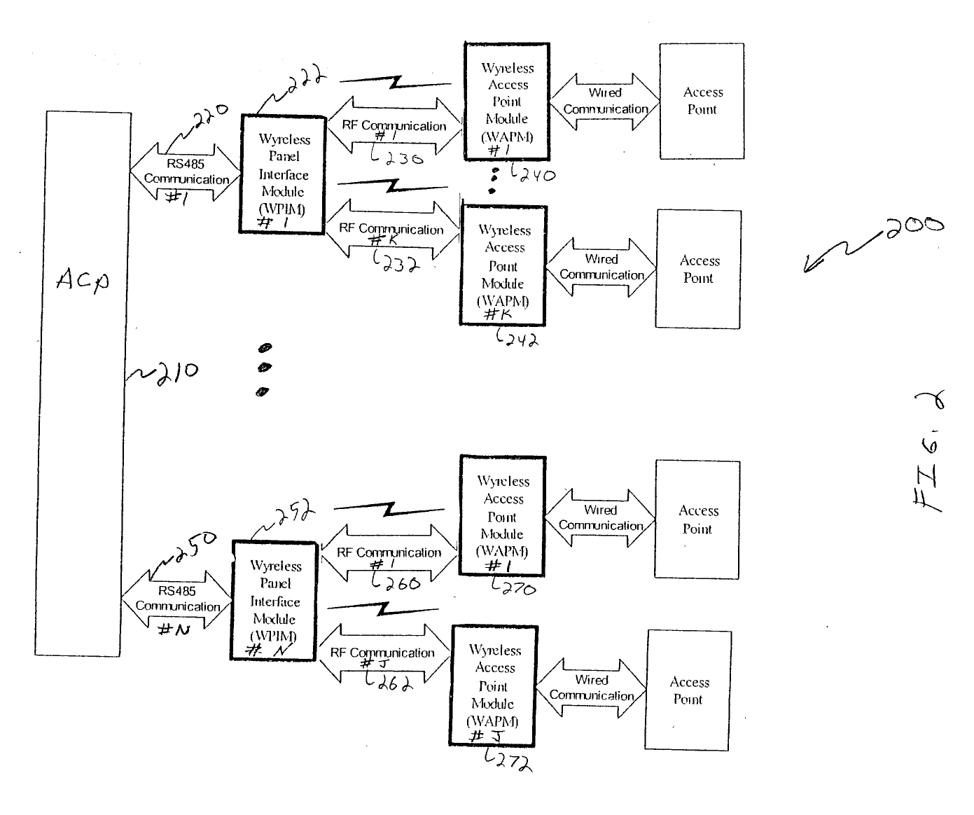

FIG. 2 illustrates a block diagram of the components of an expanded wireless access system 200 according to a preferred embodiment of the present invention. The expanded wireless access system 200 includes an ACP 210, multiple wired communication links 220, 222 numbered 1 to N, multiple WPIMs 222, 252 numbered 1 to N, multiple RF communication links 230, 2323, 260, 262 numbered 1 to K and 1 to J, and multiple WAPMs 240, 242, 270, 272 numbered 1 to K and 1 to J. The expanded wireless access system 200 is similar to the access system 100 of FIG. 1, and includes the same components, but has been expanded to include multiple access points, WAPMs, and WPIMs.

In the expanded wireless access system 200, a single ACP 210 communicates with a number N of WPIMs 222, 252 over a number N of wired communication links 220, 250. That is, the ACP supports communication with and provides access decisions for plurality of WPIMs 222, 252. Each WPIM 222, 252 may in turn support a plurality of WAPMs 240, 242, 270, 272 each WAPM positioned at a single access point. For example, WPIM #1 communicates with a number K of WAPMs 240, 242 over a number K of RF communication links 230, 232. Additionally, WPIM #N communicates with a number J of WAPMs 270, 272 over a number J of RF communication links 260, 262.

In a preferred embodiment, the ACP 210 supports three WPIMs and each PIM can support up to six WAPMs. However, as more advanced and configurable systems are developed, the total numbers of WPIMs and WAPMs supported is expected to rise. Additionally, the N wired communication links 220, 250 are illustrated as the preferred embodiment of RS486 communication links. Alternatively, other well-known communication protocols may be employed.

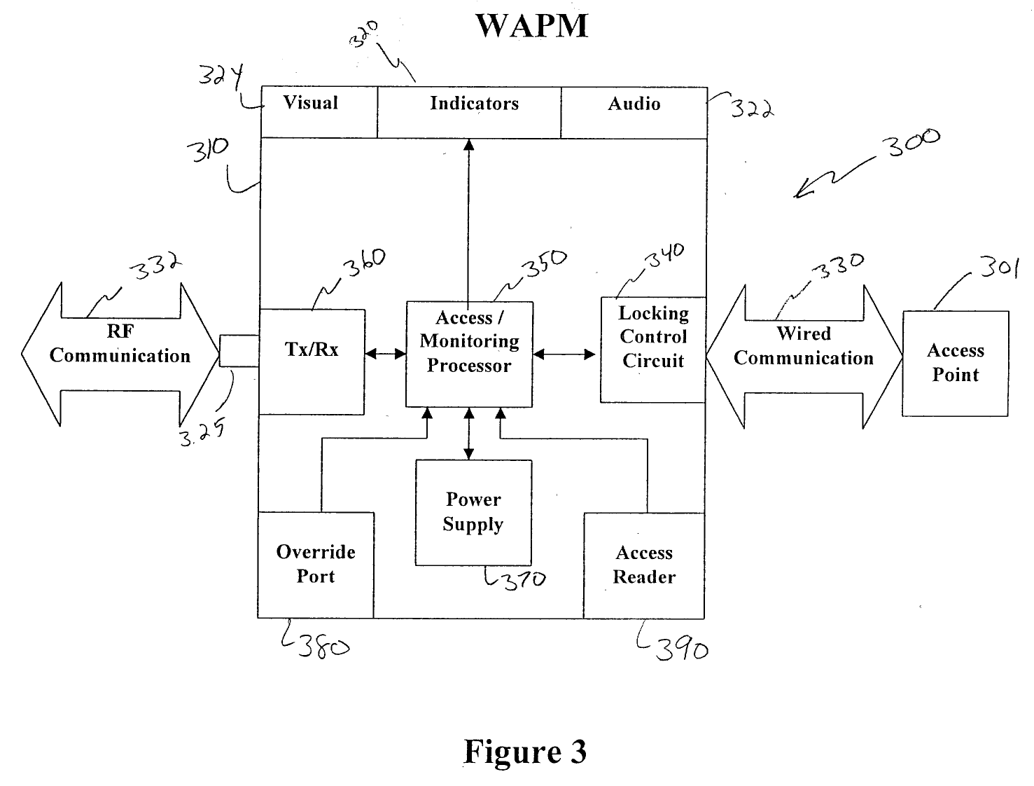

FIG. 3 illustrates a Wireless Access Point Module (WAPM) 300 for the wireless access system 100 of FIG. 1 according to a preferred embodiment of the present invention. The WAPM 300 includes a housing 310, indicators 320, a wired communication link 330, a RF communication link 332, and an antenna 325. The housing 310 includes a locking control circuit 340, an access/monitoring processor 350, a transceiver 360, a power supply 370, an override port 380, and an access reader 390. The indicators 320 may include one or both of an audio indicator 322 and a visual indicator 324. An access point 301 is also shown in FIG. 3.

The power supply 370 provides power to all of the other systems of the housing 310, including the transceiver 360, the locking control circuit 340, and the access/monitoring processor 350. The power supply 370 may be an internal battery or other internal type of power supply. Alternatively, an AC power supply may be employed. The transceiver 360 is coupled to the antenna 325 to allow signals to be sent and received from the housing 310 to an external point such as a WPIM through the RF communication link 332. The locking control circuit 340 is coupled to the access point 301 and provides locking control signals to the access point 301 through the wired communication link 330. Additionally, the locking control circuit 340 may receive feedback from the access point 301 through the wired communication link 330, for example to verify that the access point is secured. The access reader 390 receives access signals such as from an integrated card reader or other access device, for example. The indicators 320 may provide a visual or audio indication, for example, of the state of the WAPM 300 or that an access signal has been read by the access reader 390.

In operation, an access signal may be received from the access reader 390. The access signal is then relayed to the access/monitoring processor 350. The access/monitoring processor 350 then sends the access signal to the transceiver 360. The transceiver 360 transmits the access signal to WPIM 120 of FIG. 1 that is interfaced to the ACP 110. As further explained below, the ACP 110 includes a database of authorized access signals. If the access signal received from the WAPM 300 is determined by the ACP 110 to be a signal corresponding to an authorized user, a confirmation is transmitted from the ACP 110 to the WPIM 120 and then to the transceiver 360 of the WAPM 300. The confirmation is relayed from the transceiver 360 to the access/monitoring processor 350. The access/monitoring processor 350 then sends a locking control signal to the locking control unit 340. When the locking control unit 340 receives the locking control signal, the locking control unit 340 activates the access point 301 through the wired communication link 330 to allow access. The indicators 320 may be a visual or audible signal that the housing 310 has read an access signal, transmitted the access signal to the remote access control panel, received a confirmation, or activated the locking member, for example.

The WAPM 300 may include several variations. For example, the WAPM may be an Integrated Reader Lock (WAPM), a Wireless Reader Interface (WRI), a Wireless Integrated Strike Interface (WISI), a Wireless Universal Strike Interface (WUSI), or a Wireless Portable Reader (WPR). The WAPM includes an integrated access reader and lock. That is, the WAPM is similar to FIG. 3, but includes the access point as part of the housing. The WRI is similar to the WAPM, but does not include an integrated access reader and instead receives signals from a third party access reader. The WISI includes an integrated reader and lock and is mounted directly into the strike of the access point, such as a door, for example. The WUSI is similar to the WISI, but does not include an integrated reader and lock and may instead be connected to a third party reader and/or lock. The WPR is a portable reader that may be taken to a remote location and determine access decisions at the remote location, for example, for security checks or badging checks.

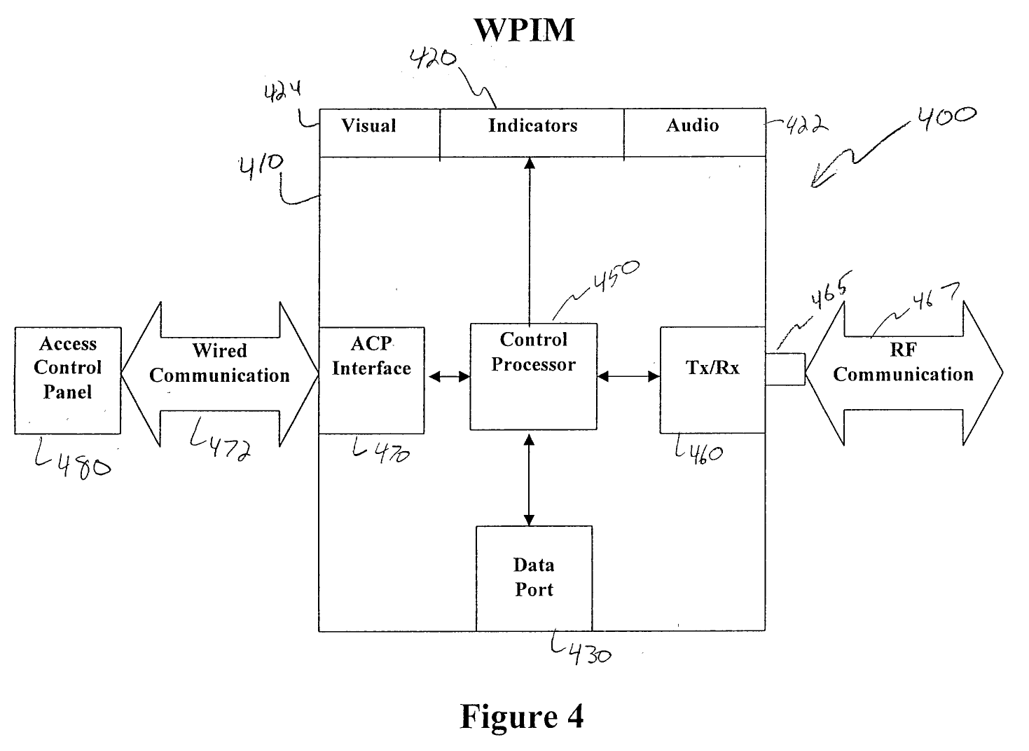

FIG. 4 illustrates a WPIM 400 for the wireless access system 100 of FIG. 1 according to a preferred embodiment of the present invention. The WPIM 400 includes a housing 410, an antenna 465, and indicators 420. The housing 410 includes a data port 430, a control processor 450, a transceiver 460 and an ACP interface 470. FIG. 4 also shows an RF communication link 467, a wired communication link 472, and an ACP 480.

Power is typically supplied to the WPIM via an AC power supply or through the wired communication 472. The transceiver 460 is coupled to the antenna 465 to allow signals to be sent and received from the housing 410 to an external point such as a WAPM through the RF communication link 467. The ACP 480 is coupled to the WPIM 400 through the wired communication link 472. The data port 430 is coupled to the control processor 450 to allow an external user such as a technician, for example, to interface with the control processor. The indicators 420 may provide a visual or audio indication, for example, of the state of the WPIM 400 or that an access signal has been passed to the ACP 480 or an authorization passed to a WAPM 300.

In operation, the WPIM 400 receives access signals from the WAPM 300 through the antenna 465 and transceiver 460. The WPIM relays the access signals to the ACP 480 for decision making. Once the access decision has been made, the ACP 480 transmits the access decision through the wired communication link 472 to the WPIM 400. The WPIM 400 then transmits the access decision to the WAPM 300.

As mentioned above, the WPIM 400 includes a data port 430. The data port 430 is preferably an RS485 port. The data port 430 may be used, for example, by an operator to connect a computer to the WPIM 400 to perform various tasks, such as configuring the WPIM 400, for example. Some exemplary WPIM items for configuration include the transmission frequency for the communication link with the WAPM and the performance of the indicators 420.

Additionally, configuration information may be received by the data port 430 of the WPIM 400 and relayed to the WAPM 300 via the transceiver 460. The configuration information that is received by the WAPM 300 may then by relayed to the access/monitoring processor 350 of the WAPM 300 for implementation at the WAPM 300.

The WPIM may include several variations including a panel interface module (PIM) and a panel interface module expander (PIME). As mentioned above, a single PIM may communicate with multiple WAPMs. Additionally, the housing for the PIM is preferably constructed to allow additional PIM modules to be installed in the PIM housing to form the PIME. Because the PIME includes multiple PIM modules, the PIME may service more access points.

Several aspects of a preferred embodiment of the present invention is an access system that employs automatic determination of reader interface type, an implementation of extended unlock and encrypted communication features.

As mentioned above, preferably, the WAPM 300 communicates with an access reader 390. As mentioned above, the access reader may be inside the housing 310, or may be external to the housing 310 and connected to the housing using a wire, for example. An external access reader may be part of a previously existing access system, for example, and may be any of a wide variety of access readers including: a magnetic card reader, a proximity card reader, a Wiegand reader, and a biometric reader.

However, in practice, two types of card reader system are commonly used for access systems: magnetic card readers and Wiegand/proximity card readers. Each type of card reader employs a different data encoding/decoding format and corresponding hardware interface. Generally, the magnetic card readers employ a clock and data interface. Generally, Wiegand and proximity card readers employ a data1/data0 interface. The two types of data interfaces are mutually unintelligible. That is, a magnetic card system is unable to read a card from a proximity card system and vice versa.

Thus, a card reader must typically be configured for one type of system or the other, but not both. The configuration of the card reader is typically accomplished at manufacturing or possibly at installation. Typically, a PCB jumper or switch is set to determine the type of reader interface that the card reader accepts and reads, either clock and data or data1/data0.

In one embodiment of the present invention, the WAPM automatically determines the type of interface that the WAPM is being connected to and automatically configures itself to decode the respective card data. In order to determine the type of interface, the WAPM analyzes the waveform received from the access reader 390. The waveform received from the access reader 390 is then compared to the expected waveforms for clock/data and data1/data0 to find a match. Whichever format matches the waveform is accepted as the desired format and the WAPM 300 is configured to expect access data in the matching format. The clock/data and data1/data0 waveforms may be differentiated because the clock/data waveform involves two signals, each of which may be active at any one time, while the data1/data0 waveform also involves two signals, however, both of the signals are never active at the same time.

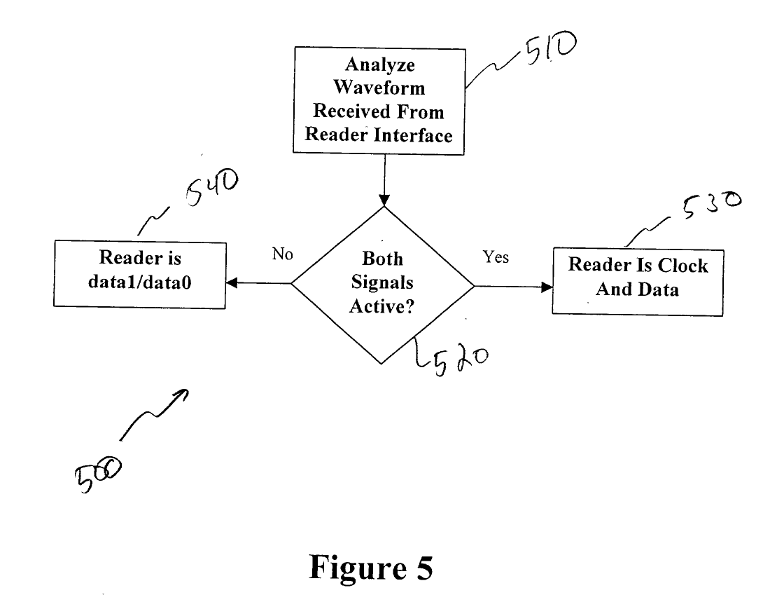

FIG. 5 illustrates a flowchart 500 of the determination of the reader interface type at the WAPM according to a preferred embodiment of the present invention. First, at step 510, the waveform received from the reader interface is analyzed. Next, at step 320, the two signals of the received waveform are analyzed. If the two signals are both active at the same time, the reader interface is determined to be a clock/data interface and the WAPM is so configured at step 530. If the two signals are not both active at the same time, the reader interface is determined to be a data1/data0 interface and the WAPM is so configured at step 540.

As mentioned above, the WPIM 400 includes a data port 430. The data port 430 is preferably a four-wire full or half duplex RS-485 port. Alternatively, the data port 430 may be a two-wire, half duplex RS-485 port. Additionally, the data port may be a multiwire, direct connection or an RS-232 port.

The data port 430 may be used, for example, by an operator to connect a computer to the WPIM 400 to perform various tasks, such as configuring the WPIM 400 and WAPM 300, for example. Some exemplary WPIM configurations include the transmission frequency for the communication link with the WAPM and the performance of the link indicators 420.

Alternatively, the data port 430 may be used as a communication link between the WPIM 400 and a remote ACP 110 of FIG. 1. Thus, the connection between the WPIM 400 and the remote ACP may be more robust than an interface through a card reader port. Preferably, the communication link between the WPIM and the ACP is a RS-485 interface. Using the RS-485 port, individual alarms including WAPM identifiers and specific situation identifiers may be transmitted to the ACP.

Additionally, in a preferred embodiment, the wireless communication link between the WAPM and the WPIM employs spread spectrum techniques, preferably direct sequence spread spectrum. By using a spread spectrum communications format, signals being transmitted between the WAPM and WPIM are encrypted with a pseudo random number (PN) code.

Additionally, the communications between the WAPM and WPIM preferably employ time slotting and handshaking, as well as unique addressing for each WPIM and WAPM to maintain a level of encryption and privacy that is very difficult to overcome. Additionally, communications between the WAPM and the WPIM may be further encrypted using poly codes, matrix keying, or one-time codes.

The time slotting and handshaking provide a very small time window of opportunity where a response is be accepted by the WAPM. Consequently, this small time window makes it much more difficult for a rogue response to be generated and cause an unwanted action, such as unlocking the door without authorization.

Additionally, in a preferred embodiment, the WAPM may be unlocked in one of two modes, momentary unlock or extended unlock. The momentary unlock mode is the typical unlock mode which may be employed by a single user to gain access to the WAPM, for example in response to a card swipe or other manual entry. The extended unlock mode provides access through the WAPM for a longer period, for example during working hours from 8 am-5 pm.

As described above, during a momentary unlock mode, an access request may be received at the WAPM and then passed to the WPIM. The WPIM then passes the access request to an access control panel. The access control panel makes an access determination and relays the access determination to the WPIM. The WPIM in turn relays the access determination to the WAPM. The WAPM then either unlocks or remains locked in response to the access determination.

In extended unlock mode, the ACP sends an access determination to a particular WPIM granting access to a particular WAPM, before an access request is submitted at the WAPM. That is, extended unlock mode is set for a specific WAPM at the access control panel. The setting is then relayed to the WPIM that services the specific WAPM. The next time the WAPM contacts the WPIM, the WPIM instructs the WAPM to unlock indefinitely, that is, until extended unlock mode is terminated or timed out at the control panel.

Alternatively, the WPIM may continuously monitor the state of the access control determination received from the access control panel. When the WPIM determines that a positive access control determination has been received without an access request from an WAPM having been submitted, the WPIM places the indicated WAPM in the extended unlock mode.

Conversely, if the WPIM determines that the relay from the access control panel to the WPIM has become inactive, then the WPIM instructs the associated WAPM to lock.

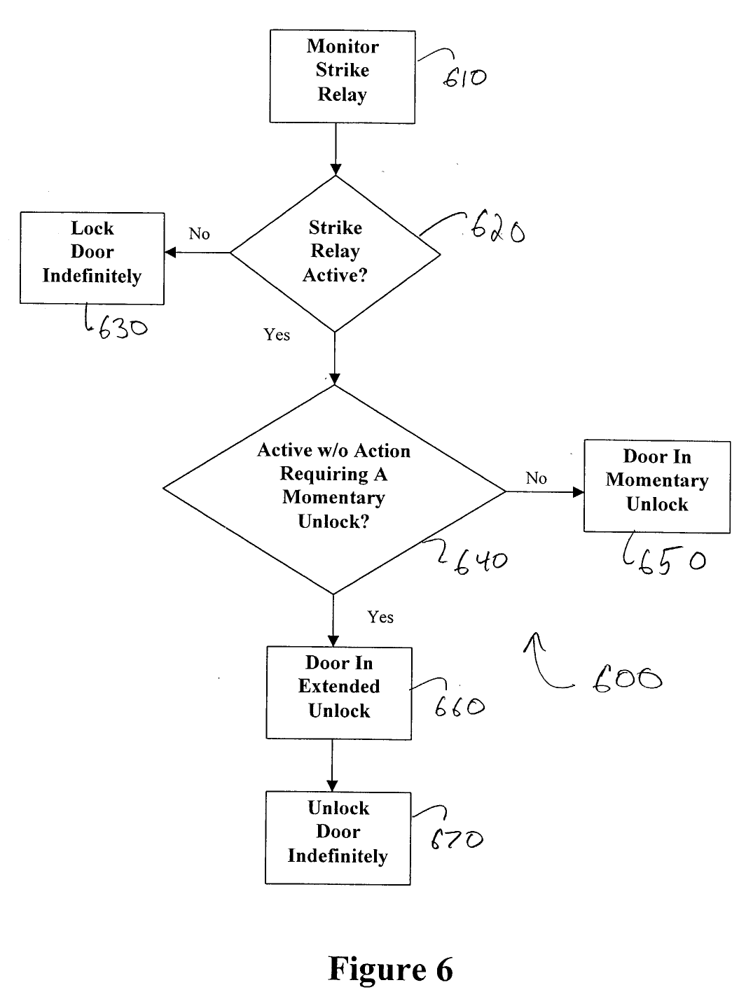

FIG. 6 illustrates a flowchart 600 of the extended unlock mode according to a preferred embodiment of the present invention. First, at step 610, the strike relay is monitored. The strike relay is the response to an access request received by the WPIM from the access control panel. At step 620, whether the strike relay is active is determined. If the strike relay is not active, the WPIM instructs the WAPM to lock indefinitely at step 630. If the strike relay is active, the flowchart proceeds to step 640.

At step 640, the WPIM determines whether a positive strike relay is being received from the control panel without an access request being submitted to the control panel. If an access request has been sent to the control panel, the WPIM considers the WAPM to still be in momentary unlock mode at step 650. If no access request has been submitted to the control panel, then the WPIM considers the WAPM to be in extended unlock mode at step 660. The WPIM then instructs the WAPM to unlock indefinitely, or until countermanded by the WPIM, at step 670.

As alternative example, the wireless access system may be configured so that each WAPM employs a heartbeat of 10 minutes. The heartbeat is preferably 10 minutes, but is configurable from seconds to days. At each heartbeat, the WAPM sends a signal identifying itself to the WPIM and requests confirmation from the WPIM that the WPIM is still in communication with the WAPM. Each WAPM is preferably configured to receive signals for only a short time after transmitting a signal in order to save power. That is, communication between the WAPM and the WPIM is controlled by the WAPM and the WAPM is unable to receive signals from the WPIM without querying the WPIM first.

Consequently, when an ACP indicates that a WAPM is to be placed in extended unlock mode, the ACP communicates the command to the WPIM. However, the WPIM is unable to communicate the command to the WAPM until the next time that the WAPM initiates a communication link with the WPIM. The WAPM may attempt to initiate a communication link with the WPIM for a variety of reasons. For example, the WAPM may have scanned a card and be seeking an access decision, the WAPM may be reporting an error or trouble condition, or the WAPM may be initiating a heartbeat signal.

Once the WAPM initiates the communication link with the WPIM, the WPIM may immediately instruct the WAPM to enter extended unlock mode. The WAPM may then enter extended unlock mode.

The same procedure is applied to remove the WAPM from extended unlock mode. That is, the WAPM must communicate with the WPIM (typically at a heartbeat) to receive instructions from the ACP

While particular elements, embodiments and applications of the present invention have been shown and described, it is understood that the invention is not limited thereto since modifications may be made by those skilled in the art, particularly in light of the foregoing teaching. It is therefore contemplated by the appended claims to cover such modifications and incorporate those features that come within the spirit and scope of the invention.

1. In an RF access control system, a method for automatically configuring a Wireless Access Point Module (WAPM) to communicate with an access reader where said access reader employs one of a plurality of access interfaces, said method comprising the steps of:
receiving a waveform from said access reader at said WAPM;
analyzing said waveform to determine whether at least two signals of said waveform are active at the same time; and
automatically configuring said WAPM to one of a plurality of access interfaces based said analyzing step.

2. The method of claim 1 wherein said automatically configuring step includes configuring said WAPM to a clock/data interface when said at least two signals are active at the same time.

3. The method of claim 1 wherein said automatically configuring step includes configuring said WAPM to a data1/data0 interface when said at least two signals are not active at the same time.

4. The method of claim 1 further including the step of communicating between said WAPM and a Wireless Panel Interface Module (WPIM) wherein said communication is encrypted.

5. The method of claim 4 wherein said encryption is spread spectrum.

6. The method of claim 1 further including the step of placing said WAPM in an extended unlock mode.

7. The method of claim 6 wherein said extended unlock mode is determined at an Access Control Panel (ACP) and said ACP communicates an extended unlock command through a WPIM to said WAPM.

8. The method of claim 7 wherein said WAPM initiates communication with said WPIM to retrieve said extended unlock command.

9. The method of claim 8 wherein said WPIM queries whether said WAPM is unlocked and if so extends the unlock.

10. The method of claim 8 wherein said WAPM is placed in extended unlock regardless of the present condition of said WAPM.

11. An RF access control system including:
an access reader wherein said access reader employs one of a plurality of access interfaces; and
a Wireless Access Point Module (WAPM) wherein said WAPM receives a waveform from said access reader, analyzes said waveform to determine whether at least two signals of said waveform are active at the same time and automatically configures said WAPM to one of a plurality of access interfaces based said analysis.

12. The system of claim 11 wherein WAPM automatically configures to a clock/data interface when said at least two signals are active at the same time.

13. The system of claim 11 wherein said WAPM automatically configures to a data1/data0 interface when said at least two signals are not active at the same time.

14. The system of claim 11 further including:
a Wireless Panel Interface Module (WPIM) communicating with said WAPM, wherein said communication is encrypted.

15. The system of claim 14 wherein said encryption is spread spectrum.

16. The system of claim 11 wherein said WAPM is placed in an extended unlock mode.

17. The system of claim 16 further including:
a Wireless Panel Interface Module (WPIM) communicating with said WAPM; and
an Access Control Panel (ACP), said ACP communicating an extended unlock command for said WAPM to said WPIM.

18. The system of claim 17 wherein said WAPM initiates communication with said WPIM to retrieve said extended unlock command.

19. The system of claim 18 wherein said WPIM queries whether said WAPM is unlocked and if so extends the unlock.

20. The system of claim 18 wherein said WAPM is placed in extended unlock regardless of the present condition of said WAPM.
